(19) United States
(12) Patent Application Publication
(10) Pub. No.: US 2015/0137536 A1
(43) Pub. Date: May 21, 2015

(54) DOOR LATCHING AND LOCK ASSEMBLY WITH QUICK-CONNECT DEVICES AND METHODS OF ASSEMBLING DOOR HANDLES, ESCUTCHEON PLATES AND LOCK BODIES UTILIZING QUICK-CONNECT DEVICES

(71) Applicant: Larson Manufacturing Company of South Dakota, Inc., Brookings, SD (US)

(72) Inventors: Michael W. Kondratuk, Brookings, SD (US); Keith Milton Kibbel, Forest Lake, MN (US); Bryan Paul Zacher, Brookings, SD (US); Allen E. Lee, Brookings, SD (US); Kelly Dean Broin Nordgaard, Gary, SD (US)

(73) Assignee: Larson Manufacturing Company of South Dakota, Inc., Brookings, SD (US)

(21) Appl. No.: 14/409,084

(22) PCT Filed: Sep. 18, 2013
(86) PCT No.: PCT/US2013/046364

§ 371 Date: Dec. 18, 2014

Related U.S. Application Data
(60) Provisional application No. 61/661,184, filed on Jun. 18, 2012.
(60) Provisional application No. 61/701,108, filed on Sep. 14, 2012.

(51) Int. Cl. E05B 55/00; E05B 15/02

(52) U.S. Cl. CPC E05B 55/00; E05B 15/02
USPC 292/336.3; 29/525.08

(57) ABSTRACT

Latching and lock mechanisms for doors are developed that are particularly designed to improve assembly of the door latching and lock mechanisms along with a door and include methods of and features for connecting inside and outside escutcheon plates together and to a lock body by way of a quick-connect connection and release mechanism. Also, features and methods permit better alignment and assembly of lock bodies, and escutcheon plates to one another and to a door.

### CROSS-REFERENCE TO RELATED APPLICATIONS

This application claims the benefit of U.S. Provisional Application No. 61/661,184, filed Jun. 18, 2012, and entitled “DOOR LATCHING AND LOCK ASSEMBLY WITH CAM CONNECTORS ACCESSIBLE FROM A DOOR SIDE EDGE”, and U.S. Provisional Application No. 61/701,108, filed Sep. 14, 2012, and entitled, “DOOR LATCHING AND LOCK ASSEMBLY WITH QUICK-CONNECT DEVICES AND METHODS OF ASSEMBLING DOOR HANDLES, ESCUTCHEON PLATES AND LOCK BODIES UTILIZING QUICK CONNECT DEVICES, the disclosures of which are incorporated herein by reference in their entireties.

### TECHNICAL FIELD

The present invention is directed to latching and lock mechanisms for doors, and in particular to an assembly for door latching and lock mechanisms and a manner of connecting inside and outside escutcheon plates together and to a lock-body by way of a quick-connect connection and release mechanism.

### BACKGROUND

Mechanisms for latching and locking closed doors have been developed for the purposes of providing the latching and locking functionality together or independently, and emphasis has been made on providing easier installation and hiding the connectors that are utilized. In particular, a typical assembly and installation includes mounting an outside door escutcheon plate and an inside escutcheon plate together to one another by way of a lock body that is positioned within a recess or void of a door thickness as such recess is accessible from a door side edge.

Typical installation assemblies require the use of a screw or similar connector that passes through one of the escutcheon plates, through or near the locking body to position it in place and then into a threaded bore or similar element of the other escutcheon plate. Or, the screw can pass through both escutcheon plates and be connected with a nut. In either case, at least one connector end is preferably hidden in some way, such as by providing a covering element that is fixed in place over the connector end to hide it. Also, such installation techniques generally are cumbersome in that the outside and inside escutcheon plates must be held in place along with the lock body, while at the same time a connector is threaded through multiple bores or openings all held in alignment. Then, multiple turns of the screw, for example, must be conducted to finally secure the assembly together, which operation must be conducted for each of plural such connectors.

### SUMMARY

The present invention is directed to techniques and components to modify a connection of a lock body and escutcheon plates to one another and with a door. In particular, the present invention is directed to manners of improving the ease in connections and assemblies of components.

In one aspect, the present invention is directed to a latching and locking mechanism for installation within a door recess comprising an outside escutcheon plate combined with an outside door handle that is rotationally connectable with the outside escutcheon plate and including a handle shaft, an inside escutcheon plate combined with an inside door handle that is rotationally connectable with the inside escutcheon plate and including a handle shaft, a lock body including a live bolt that is operationally connectable with the handle shafts of the outside and inside handles so that rotation of either of the outside and inside handles can cause linear movement of the live bolt, and a quick-connect system provided operatively between the outside escutcheon plate and the inside escutcheon plate for connecting and urging the outside and inside escutcheon plates toward one another, wherein such a quick-connect fastener comprises the ability to connect the outside and inside escutcheon plates by way of a manipulation of an activation component of a fastener. In certain embodiments, the activation component of the fastener is a rotational component for rotational manipulation so that with up to or less than a full 360 degree rotation of the activation component, the outside and inside escutcheon plates can be secured together and biased toward one another. In one embodiment, the rotational component comprises a partial turn fastener that extends between the outside and inside escutcheon plates and through the lock body. In another embodiment, at least one of the outside escutcheon plate and the inside escutcheon plate includes a pin element that extends toward the other of the outside and inside escutcheon plates when assembled with the lock body and the lock body comprises a cam element, as the rotational component, that interacts with the pin and can be accessed from an open side edge of the lock body for movement of the cam element, and wherein movement of the cam element causes movement of the pin toward the other escutcheon plate for connecting the pin and the escutcheon plate from which it extends to the lock body.

In another aspect, the present invention is directed to a latching and locking mechanism for installation within a door recess comprising an outside escutcheon plate combined with an outside door handle that is rotationally connectable with the outside escutcheon plate and including a handle shaft; an inside escutcheon plate combined with an inside door handle that is rotationally connectable with the inside escutcheon plate and including a handle shaft; and a lock body including a live bolt that is operationally connectable with the handle shafts of the outside and inside handles so that rotation of either of the outside and inside handles can cause linear movement of the live bolt, and a mortise plate assembled with the lock body, the mortise plate including an opening through which the live bolt can pass during its linear movement by rotation of either handle, wherein the mortise plate further includes a quick attachment element that includes a first portion for engagement with an inside surface of a door edge during installation and a second portion for engagement with an outside surface of the same door edge during installation for capturing the door edge and securing the mortise plate and thus the lock box in position to a door.

In yet other aspects, the present invention is directed to methods of connecting a latching and locking mechanism to a door opening utilizing quick connect features of the lock box, escutcheon plates, and/or the mortise plate.

### BRIEF DESCRIPTION OF THE DRAWINGS

FIG. 1 is a perspective view of a latching and locking mechanism of the present invention including outside and inside escutcheon plates, handles, a lock box, and a mortise plate;

FIG. 2 is a side view of the latching and locking mechanism of FIG. 1;

FIG. 3 is a side view of the latching and locking mechanism of FIGS. 1 and 2 without the handles;

FIG. 4 is an enlarged side view of a portion of the latching and locking mechanism of FIG. 3 as viewed from the opposite side of the mechanism from that illustrated in FIG. 3, showing a rotational cam as a quick connect feature;

FIG. 5 is an enlarged side view of a portion of the latching and locking mechanism of FIG. 3, but with the rotational cam shown in cross-section;

FIG. 6 is perspective view of a rotational cam element in accordance with an aspect of the present invention;

FIG. 7 is a perspective view of the lock body and escutcheon plates of FIG. 1;

FIG. 8 is a top view of the lock body and escutcheon plates of FIG. 1;

FIG. 9 is a top view of the lock body and escutcheon plates of FIG. 1 that is similar to FIG. 8 and also schematically showing an installation to a door;

FIG. 10 is an exploded perspective view of another latching and lock mechanism of the present invention including outside and inside escutcheon plates, handles, a lock box, and a mortise plate, and further with a partial turn fastener system for connecting the escutcheon plates and lock box;

FIG. 11 is a cross-sectional side view of the position of an alignment and quick connect aspect of a mortise plate to a door edge;

FIG. 12 is side view of a partial turn fastener in accordance with the present invention shown for connecting inside and outside escutcheon plates with one another but not in an installed position;

FIG. 13 is side view of the a partial turn fastener as positioned in FIG. 12 showing radial tangs aligned with the slot of a slotted receiver;

FIG. 14 is similar to FIG. 12, but with the fastener in an installed position;

FIG. 15 is similar to FIG. 13, but with the fastener in an installed position;

FIG. 16 is a perspective view of a partial turn fastener in accordance with the present invention prior to engagement with a receiver;

FIG. 17 a perspective view of a partial turn fastener in accordance with the present invention after engagement with a receiver;

FIG. 18 is another perspective view of a partial turn fastener in accordance with the present invention showing an alignment aspect;

FIG. 19 is a side view of the partial turn fastener of FIG. 18 partially in cross-section;

FIG. 20 is a perspective view of the partial turn fastener of FIG. 18 with the tang aligned with a slot of a receiver; and

FIG. 21 is a perspective view similar to FIG. 20 with the tang engaged with a receiver.

### DETAILED DESCRIPTION

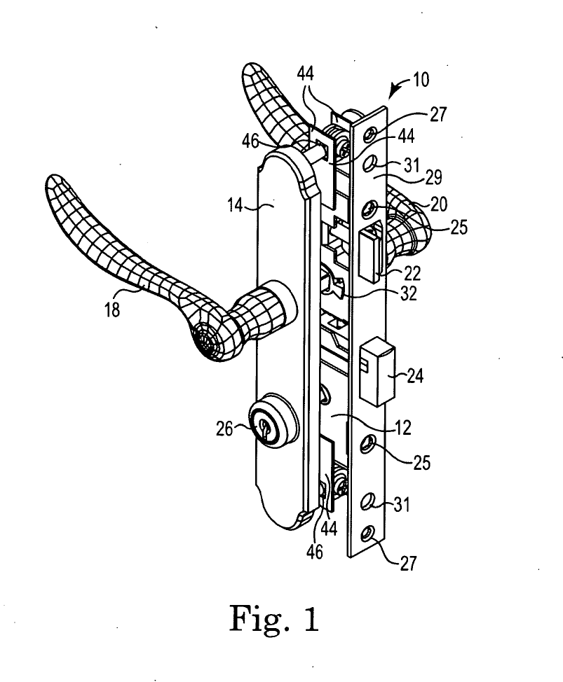

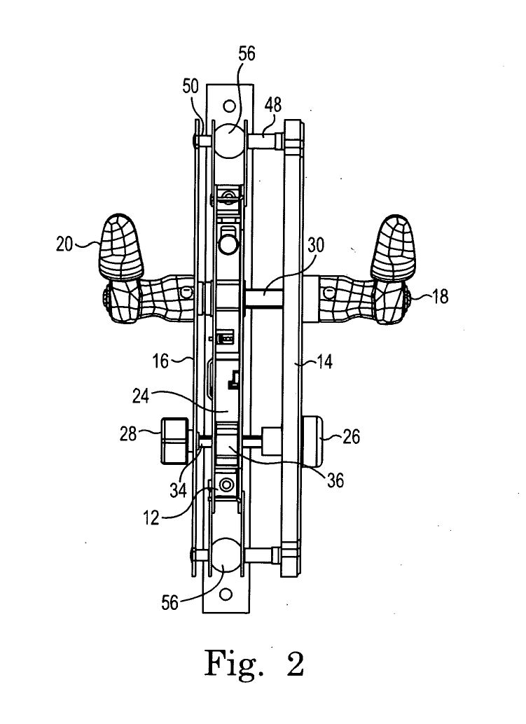

With reference to the attached figures, and initially to FIGS. 1 and 2, a door latching and lock assembly 10, in accordance with the present invention, is described as follows as comprising a lock body 12 that is operatively connected between an outside escutcheon plate 14 and an inside escutcheon plate 16.

The outside and inside escutcheon plates 14 and 16 provide the decorative plates that surround an outside door handle 18 and an inside door handle 20 and also provide part of the structural connection between the handles 18 and 20 to the lock body assembly 12. Preferably, the outside and insider handles 18 and 20 are operatively connected together so as to turn together and to control the movement of a live bolt 22 for latching and unlatching a door to a strike plate (not shown). The live bolt 22 is operative movably supported within the lock body assembly so as to move linearly in response to rotary movement of the outside and inside handles 18 and 20 as connected to move together.

A dead bolt 24 is also preferably operatively provided for linear movement to and from the lock body 12. As illustrated, the dead bolt 24 can be controlled by a key cylinder 26 on one side of the latching and lock assembly 10, such as supported by the outside escutcheon plate 14, and a thumb knob 28 on the other side of the latching and lock assembly 10, such as supported by the inside escutcheon plate 16. Of course other arrangements are contemplated as are well known for controlling the dead bolt 24, wherein rotary motion is preferably converted to linear movement of the dead bolt 24 so as to be extendable from or retractable within the lock body 12.

A door edge or mortise plate 29 is shown in FIG. 1 that is preferably also provided as part of the door latching and lock assembly 10, which plate closes off the door recess into which the lock body is installed. The edge plate 29 includes openings to permit the live bolt 22 and the dead bolt 24 to pass and to permit the edge plate to be secured to the door edge, such as by screws by way of openings 27. For installation the lock body 12 is secured to the mortise plate 29 by conventional screws by way of openings 25, as shown. The lock body 12 and mortise plate 29 assembly is positioned within a side access opening or recess of a typical door. Screws as are conventionally known are used to connect the lock body and mortise plate assembly to the door by way of the openings 27 of the mortise plate 29. Also, openings 31 are provided that are aligned for purposes of accessing the connection of the outside escutcheon plate 14 and the inside escutcheon plate 16 to the lock body 12, which connection is further described below.

In accordance with the present invention, the outside handle 18 is preferably axially fixed to the outside escutcheon plate 14 so as to be rotationally movable. Such a connection can be done by any conventional technique, such as by having a handle shaft as extending from and end of the handle 18 pass through an opening of the escutcheon plate 14 so that the escutcheon plate 14 is positioned between the end of the handle 18 and a snap ring (not shown) or other similar device that is fitted within a groove of the extended handle shaft so as to permit the handle 18 to rotate relative to the escutcheon plate 14. Likewise, the key cylinder 26 of the illustrated embodiment can be similarly rotationally supported as fixed with the outside escutcheon plate 14.

The inside handle 20 and thumb knob 28 are preferably similarly rotationally connected and axially fixed with the inside escutcheon plate 16. As such, a door latching and lock assembly of the present invention generally comprises an assembly of the lock body 12 between an assembly of the outside escutcheon plate 14 with the outside handle 18, and potentially also the key cylinder 26 or similar device, and an assembly of the inside escutcheon plate 16 with the inside handle 20, and potentially also the thumb knob 28 or similar device. The dead bolt 24 and controls are optionally provided for door security as known, but if present are preferably supported by the outside and inside escutcheon plates 14 and 16 as described above.

According to a typical door assembly, the lock body 12 is provided within an opening or recess from the side edge of a door (not shown), while the outside and inside escutcheon plates 14 and 16 are positioned on the outside and inside door surfaces, respectively. That way, the outside and inside escutcheon plates 14 and 16 can be operatively connected to one another by way of the lock body 12 so that the lock body 12 can also be fixed in position within the recess of the door.

Assembly of the outside and inside handles 18 and 20 for rotational movement together can be done in any well known manner, preferably comprising one of the handles 18 or 20 having a spindle 30 extending from it that is shaped, such as square in cross-section or other non-circular geometries in cross-section, so as to fit within a similarly shaped axial opening of the other extended shaft of the other handle 18 or 20. The spindle 30 preferably also passes through an opening of a live bolt cam 32 that is rotationally supported within the lock body 12 so that rotation of the live bolt cam 32 by action of either handle 18 or 20 as they move together causes extension and retraction of the live bolt 22 from the lock body 12. A similar arrangement can be used for the dead bolt 24 including a shaped deadbolt spindle 34 for controlling deadbolt cam 36 and thus movement of the dead bolt 24.

The lock body 12 provides an operative housing of at least the live bolt 22 and the live bolt cam 32 or other functional device for controlling extension and retraction of the live bolt 22 for latching and unlatching a door with respect to a strike plate of a door frame. In the illustrated embodiment the lock body 12 also provides the operative housing for the dead bolt 24 and its dead bolt cam 36.

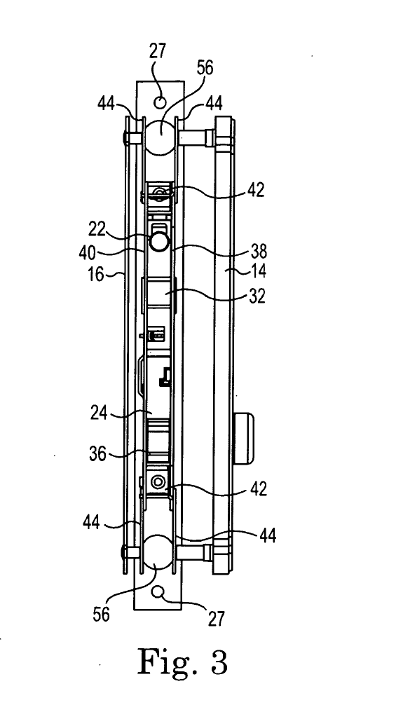

In the illustrated embodiment as shown in FIG. 3, the lock body 12 comprises a pair of spaced plates 38 and 40 that are connected together spaced preferably parallel to one another by spacer connections 42. Within the space between plates 38 and 40, the live bolt cam 32, the live bolt 22, the dead bolt cam 36 and the dead bolt 24 are each operatively movably mounted for movements as described above. The connections and operational movements of such devices are well known.

In order to provide an operative connection of the lock body 12 with the outside escutcheon plate 14 and the inside escutcheon plate 16, the plates 38 and 40 are illustrated with extension elements 44 so as to provide a pair of spaced elements 44 extending substantially parallel to one another from each longitudinal end of the lock body 12. In that position, the elements 44 would extend in the vertical direction of a door when assembled within a door recess. Each extension element 44 preferably includes an opening 46 to facilitate mounting with the outside and inside escutcheon plates 14 and 16, as described below. The extension elements 44 can be separately provided, as illustrated, and fixed to the plates 38 and 40 by any conventional manner, such as by mechanical connectors, spot welds, or any other welding or bonding technique. Alternatively, the extension elements 44 can be integrally made with the plates 38 and 40 and can be provided preferably to extend longitudinally so as to provide spaced opening 46 that can be used as follows for providing connection points with the outside and inside escutcheon plates 14 and 16.

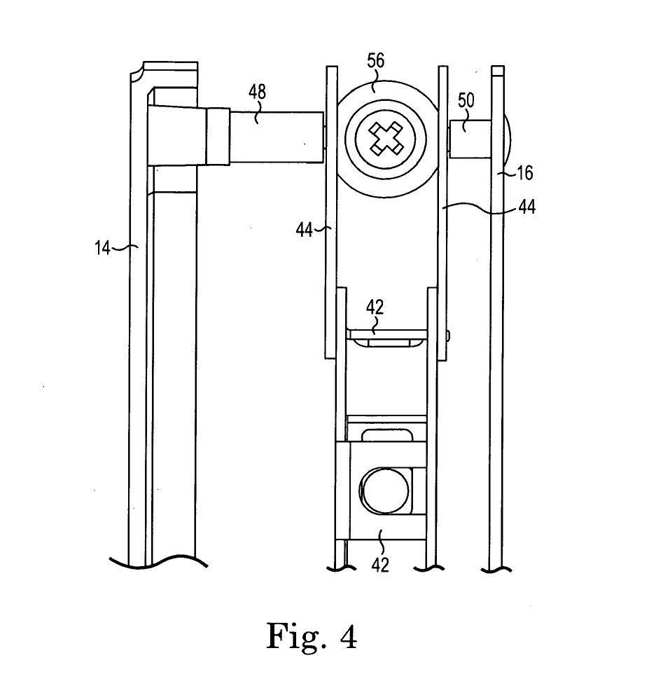

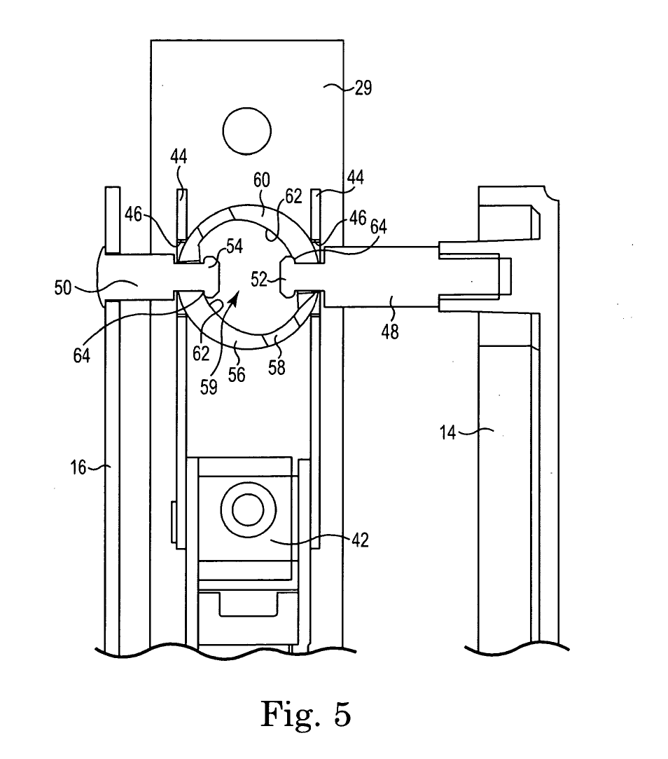

One end of the latch and lock assembly 10 is illustrated in FIG. 4. Extending from the outside escutcheon plate 14, an outside cam pin 48 extends so as to extend toward the inside escutcheon plate 16 as assembled. Likewise, an inside cam pin 50 preferably extends from the inside escutcheon plate 16 toward the outside escutcheon plate 14, preferably directly in line with the pin 48. Pins 48 and 50 preferably include a head portion 52 and 54, respectively, each having a reduced diameter portion and a larger diameter head portion, as shown in FIG. 5.

Supported between each pair of the extension elements 44, a rotational cam connector 56 is preferably provided for connecting the outside escutcheon plate 14 and the inside escutcheon plate 16. The cam connectors 56 are shown in one embodiment as being operatively supported within the space between the extension elements 44 as being partially within the openings 46. Preferably, the openings 46 are rectangular so that an outside circumferential surface of each cam connector 56 can ride along opposed edges of an opening 46 as the cam connector is rotational within the space between a pair of extension elements 44. That way, each cam connector 56 is rotationally captured between a pair of space elements 44 at the point of connection with pins 48 and 50 of the outside and inside escutcheon plates 14 and 16, respectively. Other arrangements are contemplated for rotationally supporting the cam connectors 56, such as including the provision of supporting pins, axles, bearing surfaces and the like.

Each cam connector 56 of the illustrated embodiment, comprises a pair of diametrically opposed openings 58 that are sized to permit entry of the head portions of pins 48 and 50 into an interior hollow region 50. Also, extending from each opening 58, a smaller width slot 60 is provided that is sized smaller than the size of the head portions of the pins 48 and 50, but at least as wide as the size of the reduced diameter portions of the pins 48 and 50. Interior cam surfaces 62 are provided leading from the inside of each opening 59 and extending along the sides of the slots 60 that are progressively thicker as defined by the space between interior and exterior surfaces of the cam connector 56, wherein the interior surfaces comprise the cam surfaces 62.

As shown in FIG. 5, in particular, one cam connector can be provided so as to connect both the outside pin 48 and the inside pin 50 together. The heads of each pin 48 and 50 can be positioned within the openings 58 of a cam connector 56. In this position, the head portions of each pin 48 and 50 would be positioned within the interior region 59 of the cam connector 56. Then, rotation of the cam connector 56, as facilitated by its rotational support within the space between extension elements 44, causes the cam surfaces 62 to ride along an inside surface 64 of the head portion of each pin 48 and 50. The effect of rotation and the interaction of the cam surfaces with the inside surfaces 64 causes the pins 48 and 50, and thus the outside and inside escutcheon plates 14 and 16 to be urged toward one another. The greater the degree of rotation, the greater the amount of pull or movement of the escutcheon plates 14 and 16 toward one another.

To facilitate rotational movement of each cam connector 56, a driver interface 66 is preferably provided. For example and as shown, the cam connector 56 can include a surface with a Phillips head screw slot pattern that is concentrically provided so that the cam connector 56 can be rotationally driven. Thus, as shown, with the lock body positioned within a door recess and subsequently with pins 48 and 50 of the outside and inside escutcheon plates 14 and 16 aligned and having their head portions inserted within the opening 58 of a cam connector, rotation of each cam connector 56 will independently pull the outside and inside escutcheon plates 14 and 16 together. By this action and with door portions positioned between the outside escutcheon plate 14 and a lock body plate 38 and between the inside escutcheon plate 16 and a lock body plate 40, the latch and lock assembly 10 can be fixed in position to a door with a typical door recess.

Rotation of each cam connector 56 is preferably independently controllable. An advantage of as latch and lock assembly 10 of the present invention is that access to the cam connectors 56 can be had from a door edge recess without having to provide access points for connectors through the inside and outside door surfaces as well as through the outside and inside escutcheon plates 14 and 16. That way, there are no connectors to be seen once the latch and lock assembly is connected to a door or to be covered up after installation. Moreover, by just alignment of the pins 48 and 50 to one another and with respect to corresponding bore holes through a door, the entire latch and lock assembly 10 is aligned properly for connection with the door, as such connection is effected by rotation of the cam connectors 56. Frictional forces between the external surfaces of the cam connectors 56 with the edges of the openings 46 of extension elements 44 are preferably sufficient so as to prevent rotation of the cam connectors without an applied force such as by a Phillips head screwdriver. Latch and lock assemblies of the present invention allow for quicker and easier installation. By positioning the lock body 12 within a door recess, an installer need only position both the outside and inside escutcheon plates 14 and 16 with their respective pins 48 and 50 through corresponding door bores or holes and into the cam connector 56. Then, preferably one at a time, the installer rotates each cam connector from the door edge until each creates a tight installation. The outside and inside escutcheon plates 14 and 16 are aligned to one another and with respect to the lock body 12. And, no screw heads or connector parts are apparent on either decorative face of the escutcheon plates 14 and 16 and no covering elements or technique needs to be installed or conducted. From the standpoint of the door construction, there are less bores or holes that need to be provided to accommodate the latching and locking assembly 10.

As alternatives, it is contemplated that the pins 48 and 50 need not be aligned to one another. In this case, multiple cam connectors 56 could be supported at each or one end of the lock body 12. Also, each cam connector could then include but a single opening 58 and slot 60 that are arranged to interact with but one pin. Rotational access could be provided by simply longitudinally spacing the cam connectors 56 along the lock body 12 as viewed from one side that is accessible as positioned with a door recess.

The pins 48 and 50, themselves, could take on alternative configurations. Different shapes in cross-section or in length are contemplated. Also, the pins 48 and/or 50 could be spring loaded in a manner to be axially extended or retracted depending on the effect desired and as operational with the cam connectors 56. Likewise, the interacting surfaces of the cam connectors and pins 48 and/or 50 can be modified to change the desired manner of such interaction. The slopes of the cam surfaces 62, for example, do not need to be similarly progressive to one another or such can be modified to provide an even pull or uneven pull over any degree of rotation of the cam connectors 56.

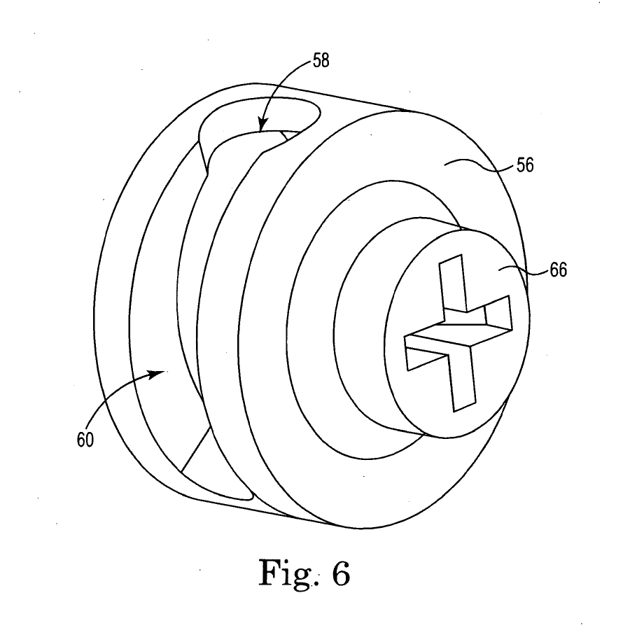

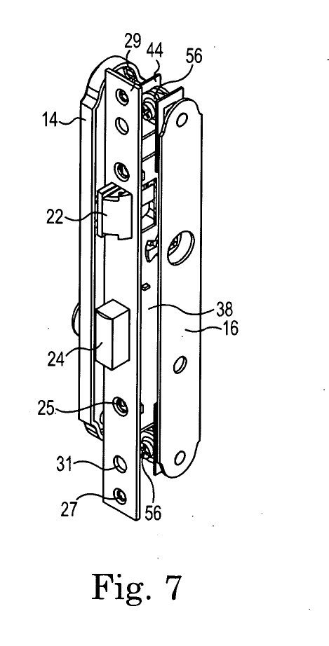

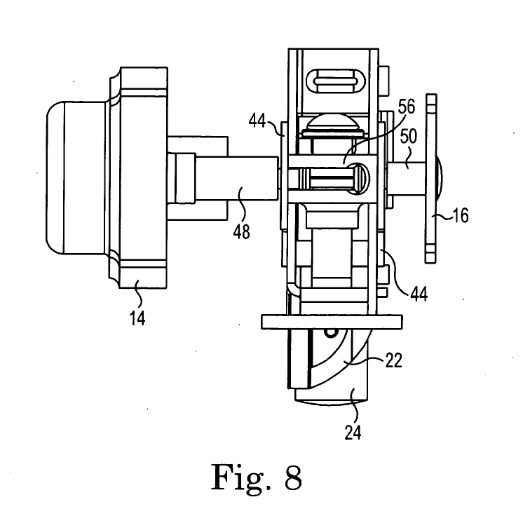

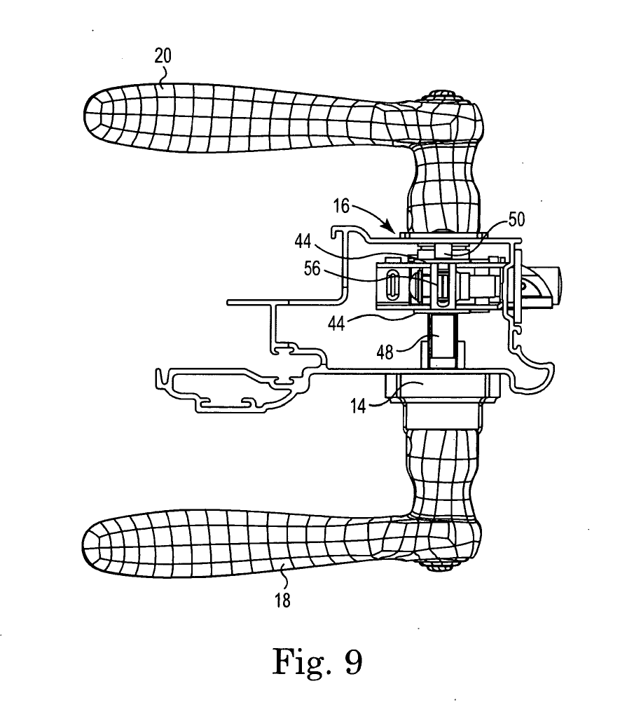

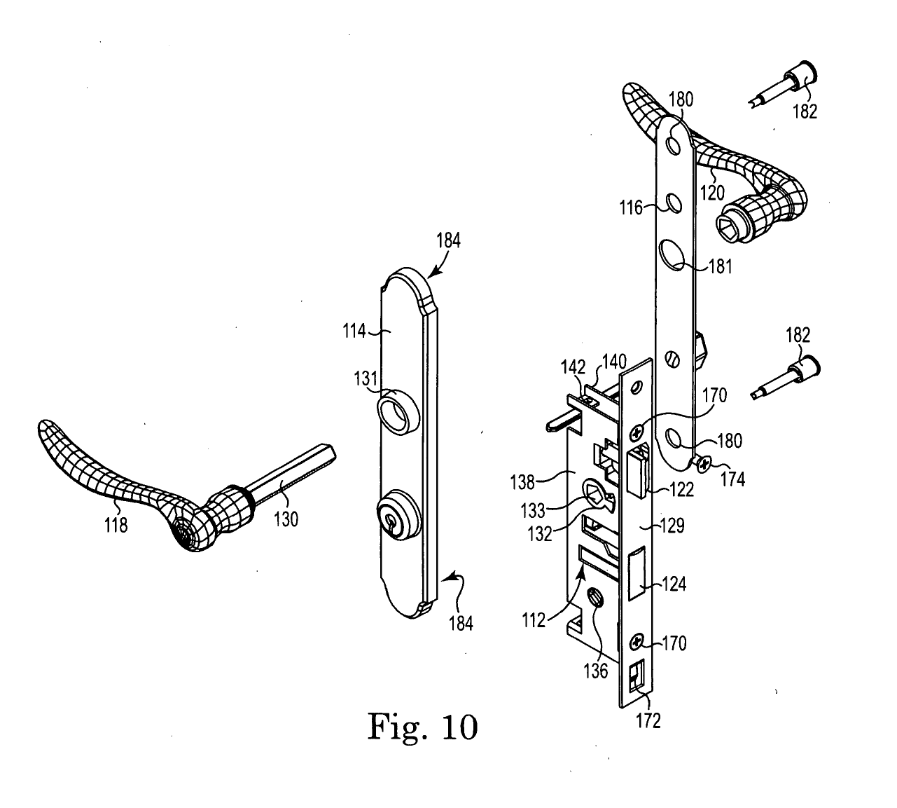

An alternative quick-type connection between outside and inside escutcheon plates 114 and 116 is illustrated within FIG. 10. In this embodiment, the common features of this embodiment as compared to the embodiment of FIGS. 1-9 are noted with similar numerals but with a 100 digit added. Reference is made to the description above with respect to an outside escutcheon plate 114, an inside escutcheon plate 116, and a lock body 112.

In the illustrated embodiment as shown in FIG. 10, the lock body 112 comprises a pair of spaced plates 138 and 140 that are connected together spaced preferably parallel to one another by spacer connections 142. Within the space between plates 138 and 140, the live bolt cam 132, the live bolt 122, the dead bolt cam 136 and the dead bolt 124 are each operatively movably mounted for movements as described above. The connections and operational movements of such devices are well known.

However, in this embodiment of the present invention, an advantageous feature is included within the construction of the lock body 112, as such lock body 112 is connected with a mortise plate 129, such as by conventional screws 170 as shown in FIG. 10, so as to create a lock body and mortise plate assembly that can be installed as a unit into a door side edge recess or side slot, as such door side recesses are well known. The mortise plate 129, in accordance with a preferred aspect, comprises a hook element 172 that can be formed out of the mortise plate 129, for example, or made separately and attached by any conventional manner.

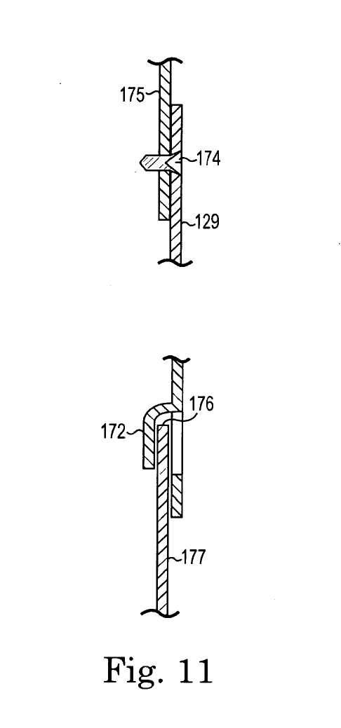

As shown in FIG. 11, the hook element 172 is illustrated as formed or shaped from the material of the mortise plate 129. A purpose of the hook element 172 is to replace one of a pair of screws as are conventionally utilized, such as illustrated by the single screw connection 174 at a top portion of a door edge 175. Specifically, the hook element 172 can be positioned over and behind a lower door portion edge 176, as such edge 176 can be provided as part of a lower door portion 177. In another modification, the edge 176 can be provided as an edge of the lower door portion 177 as such may be recessed for receiving a portion of the mortise plate 129 of the lock body 112 and mortise plate 129 assembly. Then, at the top portion 175 of a door edge, a conventional mechanical connector, such as a metal screw 174 can secure the top portion of the mortise plate 129 to the top door portion 175. The advantage of this construction is the reduction of the number of screws to be installed during a lockset installation process and the easier manipulation of the components during such installation process. With the hook element 172 in place behind the lower door portion 177, the single connector 174 can effectively secure the entire lock body 112 and mortise plate 129 in operative position. An opposite installation technique is likewise contemplated with the hook element 172 at the top of the mortise plate 129 with a fastener 174 used at the bottom. An advantage, however, of a bottom hook technique is that gravity will work to set the hook element 172 in place for alignment of a fastener 174 at the top.

Alternatively to the formed hook element 172, or any rigid version thereof whether integral with the mortise plate 129 or not, it is contemplated to utilize a flexing or articulated hook element instead. For example, a spring clip made of metal or plastic could be connected with the mortise plate 129 to extend similarly as that shown with hook element 172 that could flex or deflect in order to be positionable behind either of the door portions 175 or 177. Other type fasteners are also contemplated with respect to the screw 174, such as including expandable pins or “drive pins” as are conventionally known, whereby the insertion of a pin element within an insert provided through holes of the mortise plate 129 and a door portion 175 or 177 causes expansion of the insert behind the connected parts.

In order to provide an operative connection of the lock body 112 with the outside escutcheon plate 114 and the inside escutcheon plate 116, the inside escutcheon plate 116 is illustrated with a pair of spaced apertures 180, one preferably on either side of an aperture 181 through which the handle 120 passes, the spaced apertures facilitating the positioning of fasteners 182 through the apertures 180.

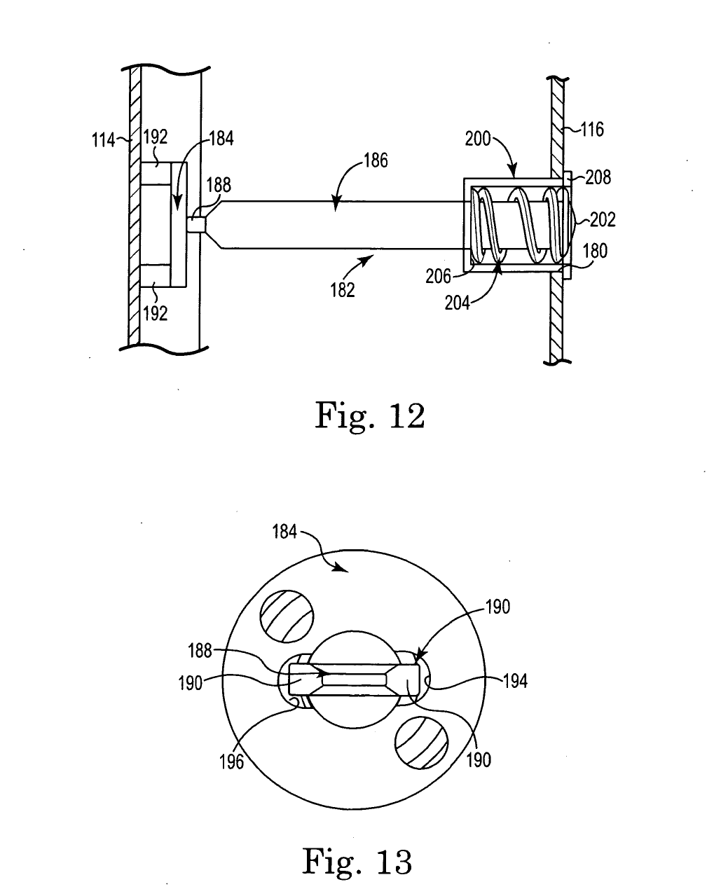

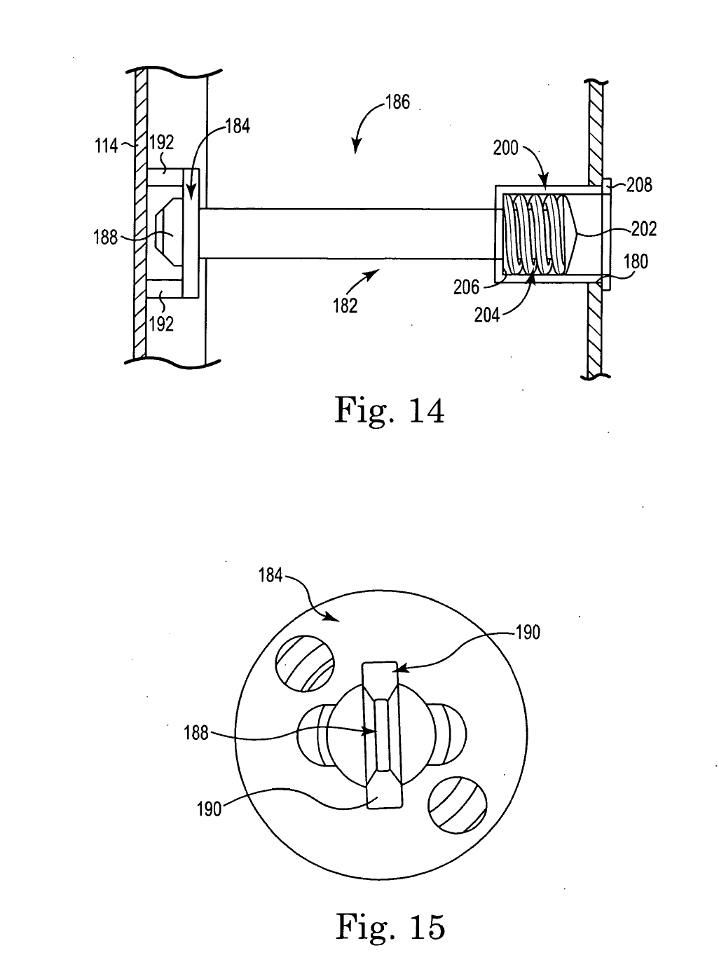

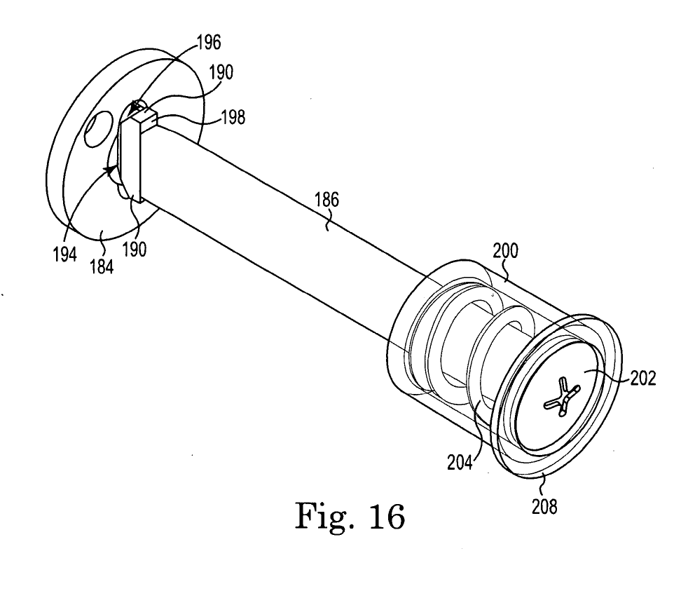

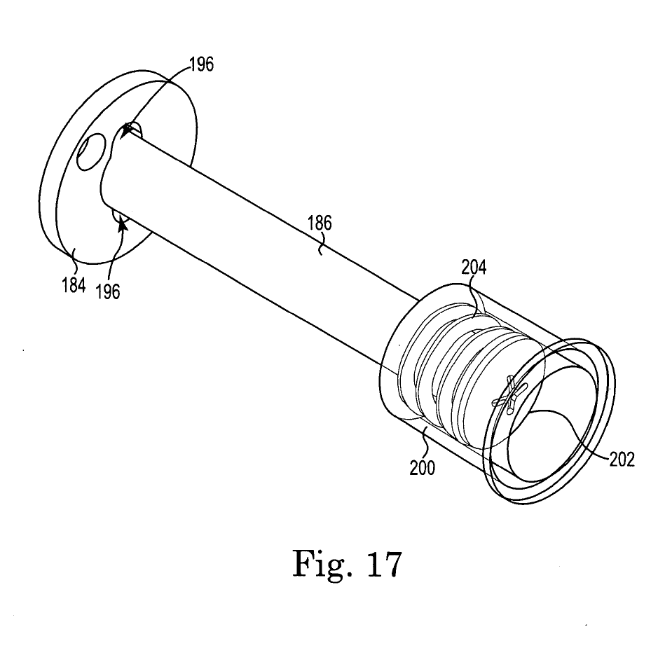

A preferred fastener 182 is a partial turn fastener, an example of which is illustrated in FIGS. 12-17. Suitable fasteners include commercially available quarter-turn fasteners, such as are available from Southco, Inc. of Concordville, Pa. In FIGS. 12 and 14, a partial-turn fastener 182 is illustrated including a spring loading for urging the outer escutcheon plate 114 and the inner escutcheon plate 116 toward one another, as such would be positioned relative to one another with a door portion between them, the door not shown in these figures.

Each fastener 182 preferably engages with a cooperating receiver 184 that is provided on the internal side surface of the outer escutcheon plate 114. More preferably, the fastener 182 and cooperating receiver 184 provide a quick-connect system so that upon only a partial rotation of the fastener 182, the outside and inside escutcheon plates 114 and 116 are preferably urged and thus drawn toward one another and secured in position together. In accordance with this aspect of the present invention, it is preferred that such a quick-connect fastener comprise the ability to be fully secured with a single manipulation of a component of the fastener 184 and, in the case of a rotational manipulation, with less than a full rotation of the component, meaning up to or less than a full 360 degrees of rotation.

In accordance with the embodiment of fasteners 182 illustrated in FIGS. 12-17, each fastener 182 is shown as comprising an elongate spindle 186 that includes a spade tip 188 having tangs 190 that extend further than the diameter of the spindle 186. As shown, the spade tip 188 is a generally linear extension providing a pair of tangs 190 and includes sloped surfaces leading from the tip proximally in order to facilitate easy insertion.

Also according to the illustrated embodiment, each receiver 184 can be mounted to the outer escutcheon 114, such as shown by boss elements 192 that can be integrally made with the outer escutcheon 114. The receiver 184 shown is circular and provided with an aperture 194 for allowing passage of the spade tip 188 when oriented rotationally in one way and for blocking removal when oriented rotationally in other ways. Other shapes of the receiver 184 and the aperture 194 are contemplated and it is understood that the receiver can be made integrally with the inner or outer escutcheons 114 and 116 or can be connected to either one by other techniques including the use of mechanical connectors, and/or by bonding or welding techniques. Moreover, the aperture 194 can be made to pass through either escutcheon 114 or 116 without the need for a separately provided component.

The aperture 194 of the receiver 184 is shown as comprising a cylindrical opening portion that is sized to allow passage of the spindle portion 186 as well as at least one, but preferably plural, and more preferably diametrically opposed, aperture portions 196 that are sized to allow passage of the spade tip 188 in at least one rotational position thereof. As can be seen by this arrangement, the spade tip 188 can be inserted through the aperture 194 in either of two aligned rotational positions of the tangs 190 with the aperture portions 196 then turned to blocking positions at all other rotational positions. It is contemplated that many other arrangements can be provided with at least one tang or extension and an aperture that allows passage in at least one rotational position and at least one blocking position based upon a partial rotation of the fastener spindle 186, for example. It is noted that the tangs 190 of the illustrated spade tip 188 have flat surfaces 198 for engagement with an inside surface of the receiver, such as when the fastener is turned to a blocking position. As described in the following, the illustrated embodiment utilizes a spring bias to urge the outer and inner escutcheons 114 and 116 toward one another. It is contemplated that along with or without such spring bias, a bias can also be created by having either the surface 198 of any one of the tangs 190 or at least a portion of the inside surface of the receiver 184 sloped to create a cam action, for example, as the tip 118 is rotated. Such rotation can create a force urging or biasing the tip 188 and spindle 186 further through the aperture 194 of a receiver for pulling the outer and inner escutcheon plates 114 and 116 toward one another.

According to the illustrated embodiment, the spindle 186 passes through an opening and into a sleeve 200 and leads to an enlarged head 202 at or closer to the end of the spindle 186 from the sleeve aperture. A compression spring 204 can then be provided to be operative between the inside end 206 of the sleeve 200 and an inside surface of the head 202. The sleeve itself also preferably includes a flange 208 that is sized to engage an outside surface of the inner escutcheon 116 as shown and to fit within an aperture 180 of the inner escutcheon 116. The sleeve 200 could otherwise be fixed, welded, bonded to or integrally made (for example by die casting) with either of the escutcheon plates 114 or 116. The head portion 202 preferably also includes a shaped engagement pattern or similar that allows for rotation of the head 202, the spindle 186, and ultimately the shaped tip 188.

According to the illustrated embodiment of the present invention, rotation of each fastener 182 can be provided from the external side of the inner escutcheon plate 116 with each fastener positioned to extend through an aperture 180 but with the flange portion of the sleeve 200 of each fastener 182 larger than the aperture 180 so as to lie against the external surface of the inner escutcheon plate 116 around the aperture 180.

As thus assembled as described above and illustrated to the inner and outer escutcheon plates 114 and 116, operation of each fastener is controlled by a partial rotation of each spindle 186, such as by rotation of the head portion 202. Operational steps once the outer and inner escutcheon plates are aligned with one another can include rotating the spindle to align the tangs 190 with the aperture portions 196 so that the tip 188 can pass through the aperture 194 of the receiver 184. Then, the spindle can be axially moved against the bias of compression spring 204 by pushing the head 202 within the limit provided by the sleeve 200. The tip 188 should at least move beyond the inside surface of the receiver adjacent to the aperture 196. Partial rotation of the spindle 186 and thus the tip 188 will result in the tip 188 being moved to a blocking position once any portion of a tang 190 moves adjacent to a surface of the receiver adjacent to the opening 194. In such blocking position, the compression spring creates a force tending to move the spindle 186 distally from the receiver 184, which action creates an urging force of the outer and inner escutcheon plates toward one another.

It is also understood that the fastener 182 and cooperating structures can be reversed with respect to the direction of insertion as to the outer and inner escutcheon plates 114 and 116, respectively. For security purposes, it may be preferable that the fastener 182 be inserted from the inner side as illustrated so that access for manipulation thereof is available only from the inside of a door so equipped.

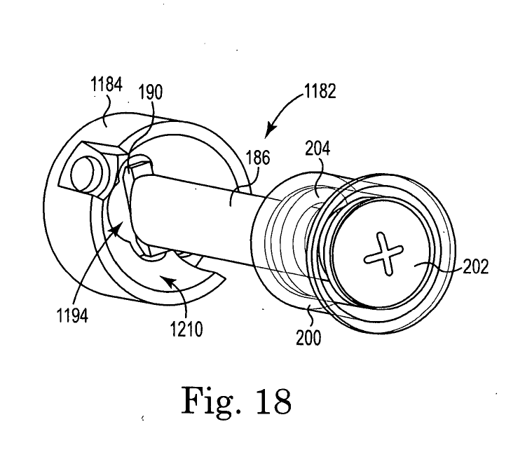

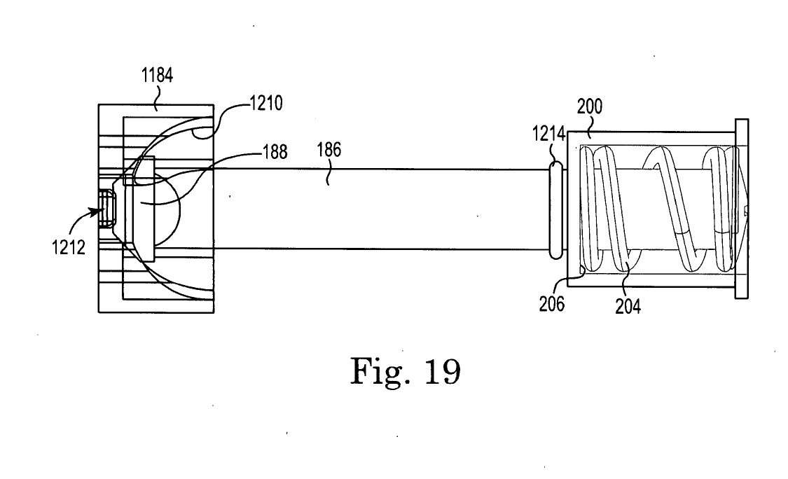

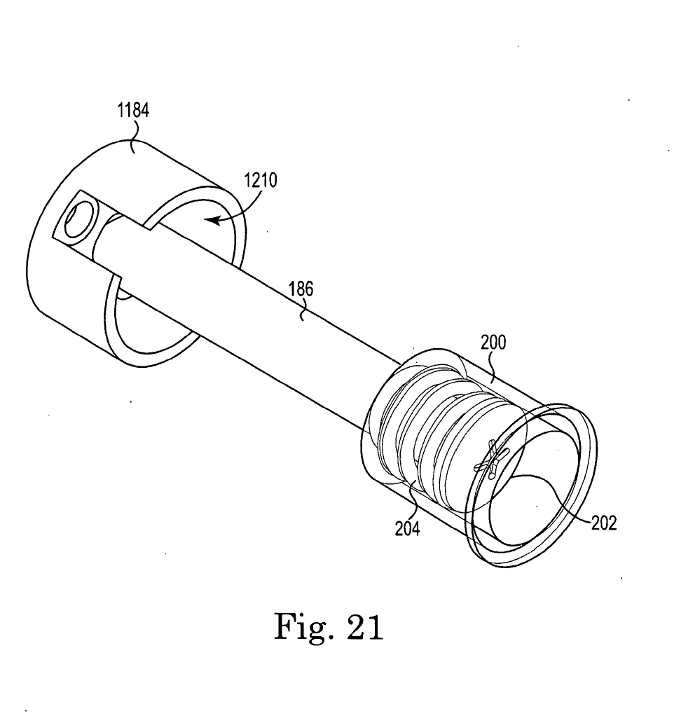

A similar fastener 1182 as fastener 182 is illustrated in FIGS. 18-21 including a modified receiver 1184, in particular. Similar components with the previously described embodiments are labeled similarly as above. According to this embodiment, a receiver 1184 would be mountable to either an outer or inner escutcheon plate 114 or 116 as described above and includes an aperture 1194 with extended aperture portions 1196 that facilitate passage of a tip 188 and shaft 186 in the same manner as described above. However, the aperture 1194 is provided at the bottom of a bowl-shaped guide surface 1210. The function of the guide surface 1210 is to align and position the tip 188 with respect to the aperture 1194 as the shaft 184 and tip 188 are moved toward the receiver 1184, such as during an installation process as described above. Once an alignment of the tip 188 is done under the guidance of the guide surface 1210, rotation of the shaft 186, such as can be controlled at the head 202, can position the tangs 190 of the tip 188 to pass through the aperture portions 1196. After full insertion, also as above, a partial further turning can result in a connected fastener 1182 and receiver 1184. The guide surface 1210 is preferably sloped or contoured, such as in the illustrated bowl shape, but need not be. Moreover, the guide surface needs to extend circumferentially about the aperture 1194, although such a guide surface 1210 design provides alignment from all radial directions. Stepped surfaces or other incongruous surfaces for a guide surfaces or guide surface portions are also contemplated.

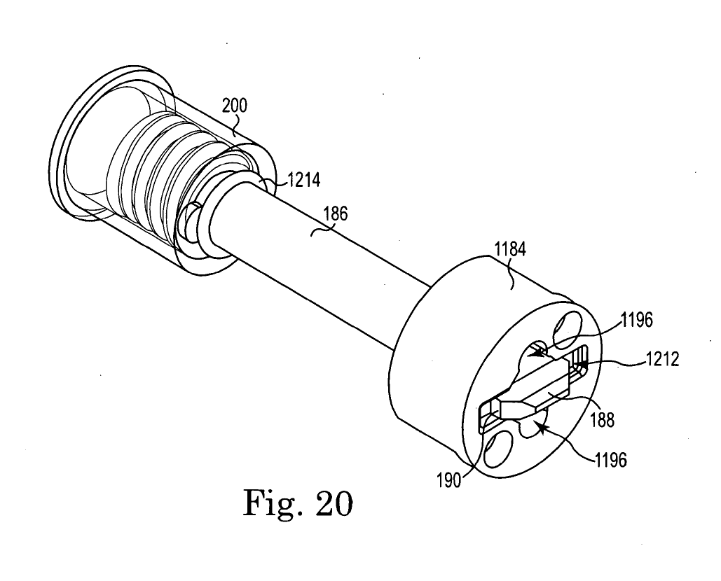

Another added feature to the embodiment of FIGS. 18-21 is a rotational detent 1212, such as shown best in FIG. 20. The detent 1212 is shown as positioned at a quarter-turn rotational position with respect to the aperture portions 1196. Thus, after insertion of the tip 188 through the aperture 1194 followed by a quarter-turn as the partial-turn, the tangs 190 can preferably be fit within portions of the detent 1212. Under the influence of the spring 204, the tip 188 is urged into engagement with the detent 1212 to maintain the fastener 1182 and receiver 1184 together axially and to resist movement rotationally. Any number of such detent positions can be created at any desired partial-turn rotational position(s).

Yet another added feature of the embodiment of FIGS. 18-21 is a ring element 1214 as can preferably also be provided at a location along the shaft 186 of the fastener 1182. The purpose of the ring element 1214 is to facilitate location of the shaft 186 and shaft head 202 relative to the sleeve 200 and spring 204, particularly during an installation process. Preferably, the ring element is located axially along the shaft 186 in order to position the head 202 at an accessible position such as at the open end of the sleeve 200, at which position, the spring 204 may or may not be compressed to any degree. A preferred ring element 1214 comprises an o-ring of elastomeric material that can frictionally maintain an axial position to the shaft 186, but yet that is moveable if desired. A fixed ring or partial ring element is also contemplated. A partial ring can be simply a boss, pin, nub, or the like extending radially from the shaft 186.

In accordance with another aspect of the present invention, an outside handle 118 can be preferably axially fixed to the outside escutcheon plate 114 so as to be rotationally movable. Such a connection can be done by any conventional technique, such as by having a handle shaft 130 as extending from an end of the handle 118 pass through an opening of the escutcheon plate 114 so that the escutcheon plate 114 is positioned between the end of the handle 118 and a snap ring (not shown) or other similar device that is fitted within a groove of the extended handle shaft 130 so as to permit the handle 118 to rotate relative to the escutcheon plate 114.

Assembly of the outside and inside handles 118 and 120 for rotational movement together can be done in any well known manner, preferably comprising one of the handles 118 or 120 having a spindle 130 extending from it that is shaped, such as square in cross-section or other non-circular geometries in cross-section, so as to fit within a similarly shaped axial opening of the other extended shaft of the other handle 118 or 120. Preferably, the spindle 130 is integrally constructed with a handle, such as the outer handle 118. More preferably, the spindle 130 is of a cross-sectional shape of a triangle, a rectangle, a pentagon, hexagon, a cross-pattern, star pattern, oval shape or torx shape (a rounded type of star pattern common in automotive fasteners), or the like. The receiver opening of the other handle, such as the inner handle 120 would thus also have a similar geometry for receiving the shaped spindle 130. The spindle 130 preferably also passes through an aperture 133 of similar geometric shape of a live bolt cam 132 that is rotationally supported within the lock body 112. As such, rotation of the live bolt cam 132 can be done by action of either handle 118 or 120 as they move together for controllable causing extension and retraction of the live bolt 122 from the lock body 112.

As shown, outside handle 118 includes the spindle 130, which passes through an opening defined preferably by a collar 131, and the inside handle 120 provides the similarly shaped axial opening into which the spindle 130 can be inserted. The opening 181 of the inner escutcheon plate 116 preferably facilitates passage of a hub portion of the inside handle 120 as such receives an end of the spindle 130. The collar 131 can be integrally made with the outer escutcheon plate 114 or separately provided and connected, such as by a threaded connection for example. By this construction, the handles 118 and 120 can be arranged on either side of the assembly so as to provide for right or left door opening as well as for preferred handle curvature orientation.

As shown in the FIG. 10 embodiment, an outside handle 118 is provided with a spindle 130 having a non-circular cross-section that can match with the shape of an aperture 133 of the live cam 132 and an axial partial passage of the inside handle 120. As illustrated, a pentagonal cross section is provided to the spindle 130 and the aperture 133 of the live cam 132 and the opening of the passage of the inside handle are similarly pentagonal. It is preferred that the cross-sectional shape and aperture and passage shape be a non-conventional shape that can be chosen to be specific of a certain door or door product line so that a purchaser can know that certain handles are designed to mate with certain doors or a door with proper alignment and fitting. Such a premise allows for the provision and marketing of different doors or lines of doors with a certainty to a customer of proper fitting of selected door handles or replacement handles as may be provided and sold separately from a door. This allows customers looking to purchase doors and handles the ability to customize the handles with a selected door from any number of handles as may be available. It is also noted that the spindle 130, and aperture 133 of the live cam 132 need not be identical in shape for a customer to fit a handle set with a door lock body, but they must be complimentary as to fit so that not only will the spindle 130 be able to pass through the aperture 133 of a lock body live bolt cam 132 but also that the spindle 130 will be effective to cause rotary motion of the live bolt cam 132 by way of a complimentary engagement between the spindle 130 and the aperture 133. For example, certain triangle shapes or trapezoidal shapes could perform these functions. It is contemplated that other shapes for the spindle 130 and aperture 133 can be equally effective.

1. A latching and locking mechanism for installation within a door recess comprising:
an outside escutcheon plate combined with an outside door handle that is rotationally connectable with the outside escutcheon plate and including a handle shaft;
an inside escutcheon plate combined with an inside door handle that is rotationally connectable with the inside escutcheon plate and including a handle shaft; and
a lock body including a live bolt that is operationally connectable with the handle shafts of the outside and inside handles so that rotation of either of the outside and inside handles can cause linear movement of the live bolt, and
a quick-connect system provided operatively between the outside escutcheon plate and the inside escutcheon plate for connecting and urging the outside and inside escutcheon plates toward one another,
wherein such a quick-connect fastener comprises the ability to connect the outside and inside escutcheon plates by way of a manipulation of an activation component of a fastener,
and further wherein at least one of the outside escutcheon plate and the inside escutcheon plate includes a pin element that extends toward the other of the outside and inside escutcheon plates when assembled with the lock body and the lock body comprises a cam element that interacts with the pin and can be accessed from an open side edge of the lock body for movement of the cam element, and wherein movement of the cam element causes movement of the pin toward the other escutcheon plate for connecting the pin and the escutcheon plate from which it extends to the lock body.

2. The mechanism of claim 1, wherein the activation component of the fastener is a rotational component for rotational manipulation so that with up to or less than a full 360 degree rotation of the activation component, the outside and inside escutcheon plates can be secured together and biased toward one another.

3-7. (canceled)

8. The mechanism of claim 1, wherein both of the outside and the inside escutcheon plates include pins that extent toward one another, which pins both engage with a cam element for causing movement of each pin toward the other.

9. The mechanism of claim 8, wherein the cam comprises a rotary cam with a drive interface and a pair of cam slots for engaging respectively with a head portion of each pin from the outside and inside escutcheon plates.

10. A method of installing a locking mechanism to a door within a recess from the side edge of a door, the method comprising the steps of:
positioning a lock body within the recess of a door from a side access opening along the door edge;
positioning an outside escutcheon plate combined with an outside door handle that is rotationally connectable with the outside escutcheon plate against an outside surface of a door;
positioning an inside escutcheon plate combined with an inside door handle that is rotationally connectable with the inside escutcheon plate against an inside surface of a door;
locating a pin element that extends from one of the outside and inside escutcheon plates toward the other of the outside and inside escutcheon plates to abut with a cam surface of a cam element that is movably supported by the lock body; and
moving the cam element by way of the side access opening of the door edge and thereby moving the pin toward the other escutcheon plate for connecting the pin and the escutcheon plate from which it extends to the lock body.

11-12. (canceled)

13. A method of installing a latching and locking mechanism to a door comprising the steps of:
inserting an assembly of a lock body and a mortise plate with a side door opening of a door that is open from the door's side edge;
locating a quick attachment element that is provided from the mortise plate near one end thereof along an edge of the side door opening, wherein the quick attachment element is located so that a first portion thereof engages with an inside surface of the door edge while a second portion of the quick attachment element also engages with a outside surface of the same door edge;
attaching a second end of the mortise plate to the door by way of a fastener passing through an opening of the mortise plate;
positioning an outside escutcheon plate combined with an outside door handle that is rotationally connectable with the outside escutcheon plate against an outside surface of a door;
positioning an inside escutcheon plate combined with an inside door handle that is rotationally connectable with the inside escutcheon plate against an inside surface of a door; and
connecting the outside and inside escutcheon plates to one another
wherein the step of connecting the outside and inside escutcheon plates comprises locating a pin element that extends from one of the outside and inside escutcheon plates toward the other of the outside and inside escutcheon plates to abut with a cam surface of a cam element that is movably supported by the lock body; and moving the cam element by way of the side access opening of the door edge and thereby moving the pin toward the other escutcheon plate for connecting the pin and the escutcheon plate from which it extends to the lock body.

14. The method of claim 13, wherein the locating step includes sliding the first and second portions of the quick attachment element relative to the door edge while also inserting the lock body within the side door opening, followed by aligning the opening of the mortise plate at the second end of the mortise plate with a complimentary opening of the door.

15-18. (canceled)
